(19) United States
(12) Patent Application Publication
(10) Pub. No.: US 2022/0044529 A1
(43) Pub. Date: Feb. 10, 2022

(54) DOORBELL IMPROVEMENTS

(71) Applicant: Willard E. Trefren, Carlisle, PA (US)

(72) Inventor: Willard E. Trefren, Carlisle, PA (US)

(21) Appl. No.: 16/984,291

(22) Filed: Aug. 4, 2020

(51) Int. Cl. G08B 3/10; G10K 15/04

(52) U.S. Cl. CPC G08B 3/10; G10K 15/04

(57) ABSTRACT

A notification system utilizing a doorbell assembly in electrical communication with a sound generating mechanism (e.g., a windchime) is described to produce sound(s). In some embodiments, the system utilizes a modification of existing elements to produce the notification system. In some embodiments, the system utilizes assembled parts as part of a notification system or assembly.

### BACKGROUND

Traditional doorbells that exist in the prior art are disadvantageous because they are not intended for aftermarket customization. Therefore, without replacing the doorbell entirely, the end consumer cannot subjectively improve the tone/quality of sound. This sound serves an important function since indicates to a home dweller that he or she has a guest. Such prior art doorbells and/or chime assemblies are shown in U.S. Pat. Nos. 5,744,736, 2,104,963, 6,124,539, 6,441,284, 6,417,763, 2,206,837, 5,072,208, 5,959,527, 6,559,367, 6,750,760, 4,326,276, 3,002,187 and US Publication Nos. 20060027071, 20070046442, 20150109111, 20070175315 all of which are hereby incorporated by reference in their entirety.

The ability to improve a doorbell's sound has distinct advantages. By improving the quality of sound produced by the doorbell, both the person going to the door and the guest, who likely heard the sound, are more likely be amiable which promotes positive social interactions. Similarly, it is more pleasing to the ear to listen to a high-end sound, in turn promoting a higher quality listening experience for the listener and leading to more amiability (e.g., between a guest and a host) who listen to the higher quality sound. Additionally, a home dweller is more likely to hear or pay attention to a higher quality sound, increasing the chance he or she will be alerted to a guest's presence.

Traditional doorbells product the same, predictable series of sounds every time they are activated. Given this predictability, they are unlikely to grab one's attention. In the Human Learning field of study, it is clear that the human brain focuses more on random events as opposed to predictable ones. Moreover, a common technique in Effective Speaking is to unpredictably lower one's voice for a sentence or two to heighten/grab the audience's attention.

Why do prior art doorbells produce the same series of sounds? For some prior art doorbells, the sound produced is digital or a replication of an instrument. This category, of prior art, is controlled by algorithms. Other prior art doorbells utilize metal parts to produce percussion-based sounds. This category is controlled by mechanical and electronic means. It is because of these stringent control mechanisms, prior art doorbells in both categories, according to their brand/model, produce the same series of sounds upon every activation.

Some prior art doorbells can be reprogrammed to play different sounds; however, they must be reprogrammed every time a different sound is desired. Of these reprogrammable doorbells, it may be possible to reprogram them to randomly select a sound/song from a list/database so that the sound produced seems random. However, every time a song is selected that song will sound the same every time; therefore, negating any qualities of uniqueness.

Consequently, a need exists to have a doorbell that produces a unique sound every time it is activated to increase the chances of it grabbing someone attention and augmenting a user listening experience. This will increase the likelihood of a guest being recognized and greeted properly.

The assembly described herein fulfills at least these needs by utilizing an actuation mechanism (e.g., a doorbell assembly) in electrical communication with a sound generating device or mechanism (e.g., a windchime) to produce a unique series of sounds.

### SUMMARY

In one embodiment, an assembly utilizes a paired radio frequency (RF) transmitter and receiver, and an electric motor with an affixed fan blade.

In one embodiment, an assembly utilizes an existing doorbell button which is subsequently modified. In one embodiment, one or more wires that activated a pre-existing sound mechanism (e.g., a chime) are rerouted to an AC to DC step-down converter which powers a transmitter (e.g., an RF transmitter). In one embodiment, when a doorbell is activated, a transmitter sends a signal to a receiver, which is housed in a modified sail of a wind chime. In one embodiment, when a signal is received, an electric fan is activated, causing movement of a sail. In one embodiment, movement of a sail results in a windchime producing a unique series of sounds.

In one embodiment, a windchime utilizes a sail including a fan element, where the windchime and sail are part of a broader notification assembly.

In one embodiment, a transmitter used in a doorbell assembly electrically communicates between a sound mechanism and a receiver which is a part of a windchime, or a sail of a windchime.

In one embodiment, a method of modifying a doorbell utilizes connecting one or more wires to an AC to DC step-down converter which powers a transmitter, where a transmitter is configured to send a signal to a receiver connected to a wind chime or a wind chime sail.

In one embodiment, a method of utilizing a doorbell comprises activating an actuation element on a doorbell, which in turn activates a transmitter to send a signal to a receiver connected to a windchime or a sail of a windchime, to activate a fan and produce a series of sounds which are conveyed to a listener.

In one embodiment, a method of producing a variable tone or sound comprises a transmitter element configured to transmit an activation function to a receiver housed on a windchime, which in turn activates a fan to produce one or more tones or sounds on the windchime which are conveyed to a user.

In one embodiment, a notification mechanism utilizes a sound generating element or device (e.g., a windchime) and an actuation mechanism (e.g., a doorbell assembly) in electrical communication with the sound generating device. In one embodiment, the actuation mechanism includes a transmitter in electrical communication with a receiver of the sound generating element to cause the sound generating element to activate a fan element of the sound generating element to create one or more sounds or tones. In one embodiment, the one or more sounds or tones are created by movement of chime elements of the sound generation element.

### BRIEF DESCRIPTION OF THE DRAWINGS

FIG. 1 illustrates a windchime utilizing sail, according to one embodiment.

FIG. 2 illustrates a sail used in a windchime, according to one embodiment.

FIG. 3 illustrates an exploded view of the sail of FIG. 3, according to one embodiment.

FIG. 4 illustrates a transmitter, according to one embodiment.

FIG. 5 illustrates an exploded view of the transmitter of FIG. 4, according to one embodiment.

FIG. 6 illustrates a traditional doorbell electronics assembly.

FIG. 7 illustrates a doorbell electronics assembly utilizing a transmitter, according to one embodiment.

### DETAILED DESCRIPTION

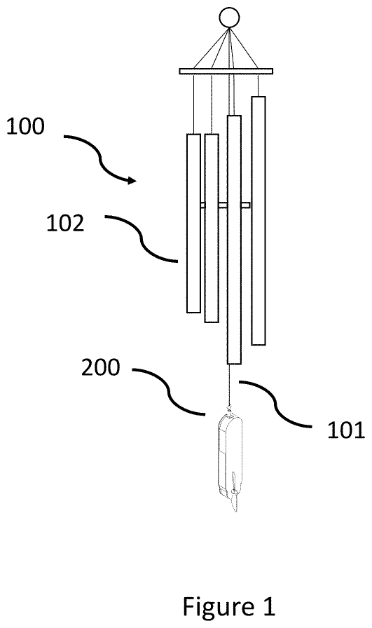

FIG. 1 illustrates a windchime 100, according to one embodiment. Windchime 100 is used along with a doorbell assembly to create a unique series of sounds, as will be discussed and described herein. Windchime 100 utilizes one or more chime elements 102, a central cord or string 101 connecting to at least one of the chime elements 102 (or alternatively linked to a structure which is connected to at least one of the chime elements 102), and a sail 200 connected to central cord or string 101.

Windchime 100 is part of an assembly that a user can use along with a doorbell interface, as will be explained herein. In one embodiment, windchime 100 is a separate and unique structure configured to operate with a doorbell interface or doorbell assembly. In one embodiment, windchime 100 is a modification of a traditional windchime where a simple sail element (e.g., a flat rectangular element configured to move with wind) is replaced by a user with an upgraded sail 200. In one embodiment, windchime 100 is an assembled or pre-assembled structure where sail 200 is included therein. Note, windchime 100 is shown illustratively though a variety of other windchime configurations can be used along with a doorbell assembly.

In one embodiment, windchime 100 includes a striker element, whereby movement of the striker element impacts the one or more chime elements 102 to produce a sound or series of sounds.

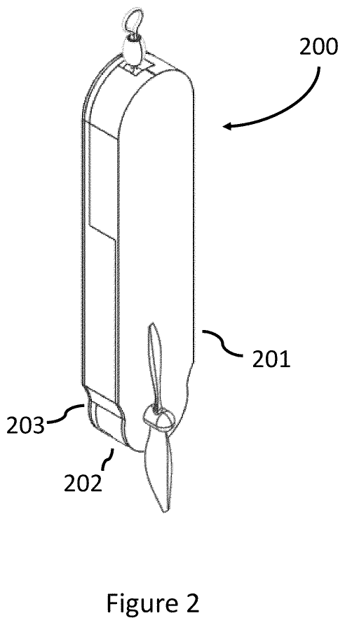

FIG. 2 illustrates sail 200 from FIG. 1 in more detail. Sail 200 is composed of three primary layers: a body cover 201, a part holder 202, and a body back 203. Each layer 201, 202, 203 is made of a material that is suitable to permit frequency wave propagation, such as wood or plastic which would be especially suitable for this purpose. Alternatively, particular metals which are configured to permit frequency wave propagation can also be used.

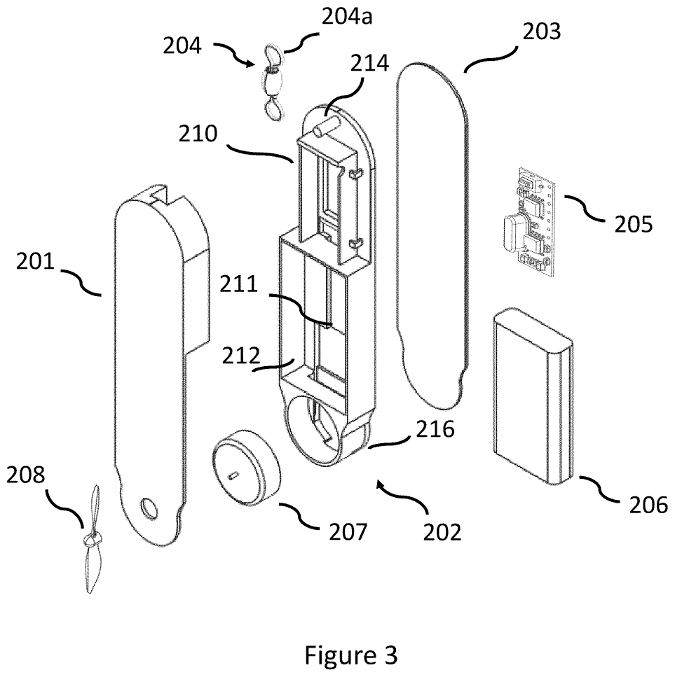

FIG. 3 illustrates an exploded view of sail 200 from FIG. 2. Part holder 202 of sail 200 holds a swivel 204 to assist sail 200 in free movement. An example of swivel 204 is Bass Pro Shops Barrel Swivel model number: BS320. Part holder 202 also includes a receiver 205, in one embodiment the receiver is a radiofrequency (RF) receiver. An example of a suitable RF receiver is Jameco part number: 2297703 manufactured by Major Brands.

Part holder 202 further includes a battery 206 and an electric motor 207 which function to actuate/rotate a fan 208 (composed of a plurality of fan blades), where electric motor 207 is connected to fan 208 to rotate fan 208. Part holder 202 also includes a wiring channel 211 to assist in wiring together RF receiver 205, battery 206, and electric motor 207 so that they are all in electrical communication. RF receiver 205 is located in a first slot 210 of part holder 202 (e.g., near a top portion of part holder 202), while battery 206 is located in a second slot 212 of part holder 202 (e.g., near a medial portion of part holder 202) and motor 207 is located in a third slot 216 (e.g., near a bottom portion of part holder 202).

In one embodiment, swivel 204 includes an eye or eyelet 204a at each end. One of the eyelets 204a is affixed to sail assembly 200 by threading an eye 204a of swivel 204 through a mounting peg 214. The other eyelet 204a is affixed to the central string 101 by threading central string 101 through eyelet 204a and then tying knot in central string 101 to affix the two together.

In one embodiment, wire leads from motor 207 and battery 206 are soldered to the corresponding pins on RF receiver 205. While these parts are setting in corresponding grooves or slots as described earlier and shown in FIG. 3, body cover 201 and body back 203 are correspondingly bonded to part holder 202 with a two-part structural adhesive such as 3M Scotch-Weld 08966 Epoxy Adhesive DP420. Thus, the parts are enclosed and secured into place.

Relating to the fan/fan blade/propeller 208, the diameter of the inner hub is similar to the shaft of said electric motor 207 so as to enable connection between the two, so that fan 208 and motor 207 are connected via the motor shaft. During assembly, the hub is firmly pressed down over the shaft so that said propeller 208 is firmly affixed.

In a manner that will be explained herein, sail 200 is in electrical communication with a doorbell via a transmitter associated with a doorbell in order to activate a sound from windchime 100. A sound is activated when the one or more chime elements 102 are contacted. In one embodiment, windchime 100 utilizes one or more striking elements to m contact the various chime elements 102. In one embodiment, the one or more striking elements are one or more enlarged regions (e.g., one or more rectangular elements) along a vertical axis of a free-hanging pendulum adjacent to the one or more chime elements 102. In one embodiment, the striking elements are just other windchimes where a plurality of chime elements 102 are used which strike each other to create a sound or series of sounds.

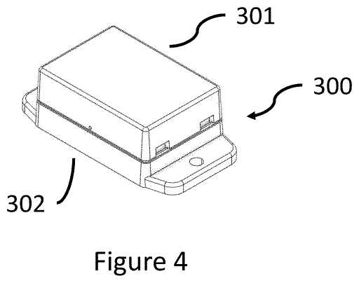

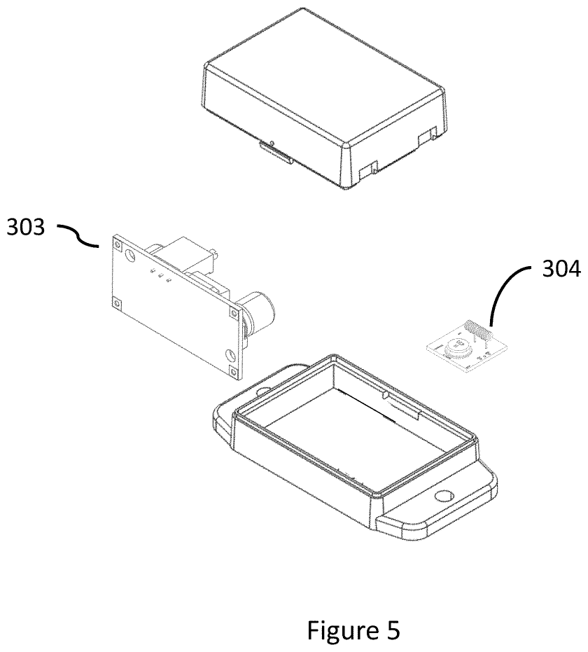

FIG. 4 illustrates a transmitter 300 which is part of a doorbell assembly, as will be explained herein. FIG. 5 illustrates an exploded view of transmitter 300 of FIG. 4. Transmitter 300 houses two parts, as shown in FIG. 5, including a converter 303 and a frequency transmitter 304. In one embodiment, converter 303 is an alternating current (AC) to direct current (DC) step down buck converter. In one embodiment, frequency transmitter 304 is an RF/radiofrequency transmitter. An example of an AC to DC step-down buck converter 304 is SMAKN DC 5V/3A(MAX) AC/DC TO DC Buck Power Converter Voltage Step Down Power Supply Waterproof Input AC 7-36V/DC 8-50V. An example of the RF transmitter 304 is Jameco part number: 2297703 manufactured by Major Brands.

In one embodiment, shown in FIGS. 4-5, transmitter 300 includes a case top 301 and case bottom 302, which in one embodiment are held together by mechanical snaps located on the outer rim of the cases. Within transmitter 300, AC to DC step down buck converter 303 and RF transmitter 304 are housed. Before securing these parts to case bottom 302, the DC output wire leads from said AC to DC step down buck converter 303 are soldered to the corresponding connection terminals on said RF transmitter 304.

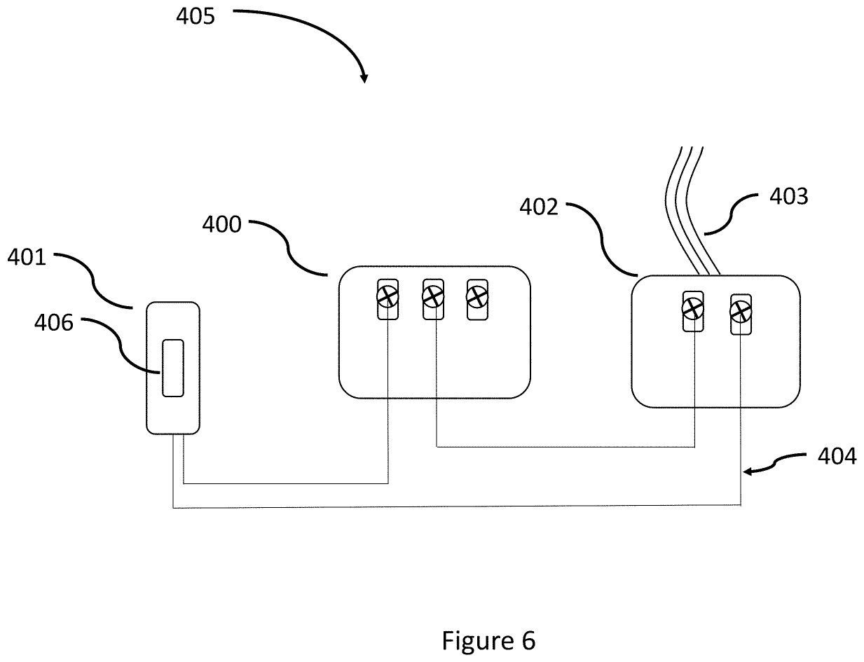

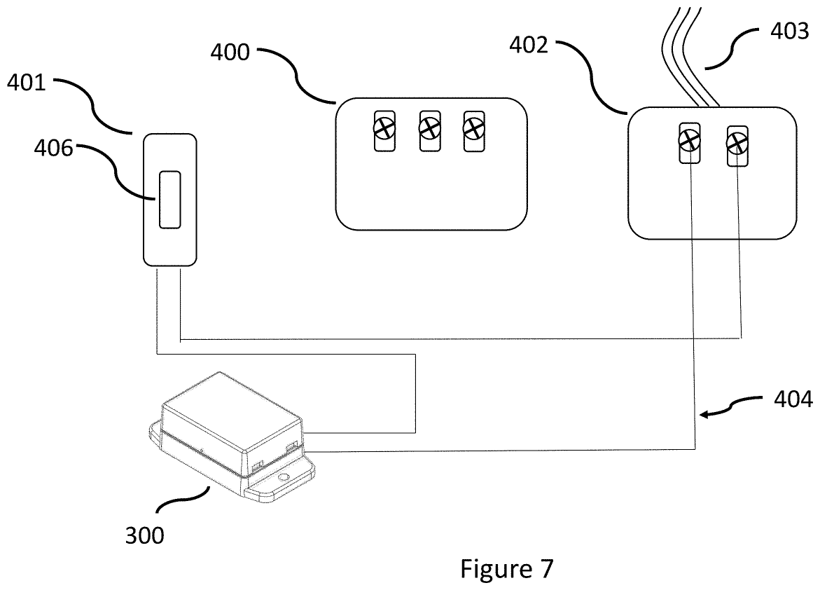

A traditional doorbell assembly 405 is shown in FIG. 6. The traditional assembly 405 is shown and explained so as to show how a traditional doorbell functions. FIG. 7, in contrast, shows a modified doorbell assembly 505 according to embodiments herein utilizing components which electrically communicate with an external structure (e.g., windchime 100 and sail 200 of FIG. 1).

A traditional doorbell assembly 405 includes an actuator 401 which has a button 406 which a user interacts with (e.g., pressing button 406). Actuator/button 406 is linked to a doorbell chime 400 through a first wire. A separate wire then links chime 400 to power transformer 402, and transformer 402 is linked to an AC power source 403. Another wire then links button 406 to transformer 402 so as to complete a circuit. Note, the various wires are generally shown as element 404. For background reference, a power transformer 402 of the traditional doorbell assembly 405 lowers a 120 Volt source (e.g., the typical United States power outlet voltage) to either 16 or 20 Volts.

FIG. 7 shows a doorbell assembly 505 according to one embodiment. In one embodiment, doorbell assembly 505 utilizes a modification of a traditional doorbell assembly (e.g., traditional doorbell assembly 405 of FIG. 6). In another embodiment, doorbell assembly 505 is a pre-made assembly therefore not requiring any modification of a traditional doorbell assembly (e.g., traditional doorbell assembly 405 of FIG. 6).

As compared to a traditional doorbell assembly 405 of FIG. 6, in FIG. 7 the series of connecting wires 404 are rerouted from doorbell chime 400 (which is routed out of the circuit and is therefore no longer needed) to transmitter 300 (which replaces doorbell chime 400 in a doorbell assembly circuit). Transmitter 300, as discussed earlier and with respect to FIGS. 4-5, includes a converter 303 (e.g., an AC to DC step-down buck converter) which converts and lowers electricity from the power transformer 402. In one example, converts an AC voltage of 16 to 20 V (output from power transformer 402) to DC 5 Volts.

In one embodiment, the AC input wire leads on the AC to DC step down buck converter 303 are joined to power transformer 402 via the screw terminals on the latter. Once the prior connection is made both converter 303 and RF transmitter 304 of transmitter 300 and are placed in the case bottom 302 of transmitter 300 (see FIGS. 4-5) so that each part has a connecting face to the inside bottom of said case bottom 302. Thereafter, a clear epoxy such as Ice Resin manufactured by Ranger is injected into the inside of said case bottom 302 so that when it cures it permanently connects the parts to said case bottom 302.

In one embodiment, where a doorbell assembly 505 is a pre-made assembly rather than a modification of an existing doorbell, the assembly 505 would include a transmitter 303 (e.g., in lieu of or in addition to a traditional doorbell chime element 400)

The operation with respect to doorbell assembly 505 and its interaction with sail 200, transmitter 300, and other elements will now be explained in more detail.

In one operation, converter 303 of transmitter 300 creates an input voltage that meets the parameters of and powers RF transmitter 304. As a result, when doorbell button 301 is pushed, a circuit is completed, power from an AC power source 403 is converted from AC to DC, lowered from AC16 to 20V to DCSV, and routed to RF transmitter component 304 of transmitter 300. RF transmitter 304, in turn, transmits a signal to the RF receiver 205 of sail 200, for example via radiofrequency (see FIGS. 2 and 3). Once RF receiver 205 of sail 200 receives the signal, power from battery 206 is routed to electric motor 207 which in turn rotates fan/propeller 208. The rotation of fan/propeller 208 creates enough force to move sail 200 and/or move chime elements 102 and/or move a striking element located near the chime elements 102 so that wind chime 100 chimes or makes a sound or noise, thereby indicating to an inhabitant that someone pushed the doorbell button.

In one operation, doorbell button 406 is pushed and thereby closes a circuit. Once the circuit is closed, AC 120V (found in United States power outlets) travels through power transformer 302. In doing so, it is lowered to AC16 to 20V. Thereafter, the power travels through said AC to DC step-down buck coveter 303 which converts it from AC to DC and again lowers it to 5V. The 5V travels to and powers RF transmitter 304, which in turn sends a signal to RF receiver 205, which is housed in sail 200.

Once said RF receiver 205 receives the signal, power from battery 206 is routed to electric motor 207 which in turn rotates said fan/blade/propeller 208. The rotation of said propeller 208 creates a force powerful enough to move sail 200 and have wind chime 100 create a unique sequence of sounds with varying degrees of volume, duration, and overall length.

In one embodiment, a unique series of sounds occurs because of ever changing environmental factors such as but not limited to: an angle at which a sail is initially facing, rotation of a sail when a fan is activated, a sequence by which one or more chimes are struck, an angle at which one or more chimes are struck, and an amount of energy a sail transfers to one or more chimes.

While the illustratively shown windchime model 100 is acceptable, and indeed preferable, it should be noted that a variety of other wind chimes, sound generating elements, and similar parts can be used with this present invention. Moreover, while particular embodiments of the invention are recommended; it will be obvious to those in the art that changes, and modifications may be made without departing from the design, functionality, spirit and/or scope of the invention. Therefore, the aim in the appended claims is to cover all such changes and modifications as fall within the true spirit and scope of the invention.

What is claimed is:

1. A notification mechanism to produce a unique sequence of tones comprising:
an actuation mechanism including a transmitter configured to activate a sound generating device; and
the sound generating device including:
at least one chime element capable of producing a tone or sound when impacted;
at least one striking element within a proximity of the at least one chime element whereby impact can occur;
a motion imparting mechanism capable of moving the at least one striking element; and
a receiver in communication with the transmitter of the actuation mechanism.

2. The notification mechanism of claim 1, wherein the actuation mechanism is a doorbell.

3. The notification mechanism of claim 1, wherein the sound generating device is a windchime.

4. The notification mechanism of claim 1, wherein the motion imparting mechanism is a fan.

5. The notification mechanism of claim 4, wherein the fan is part of a sail positioned at a bottom region of the sound generating device.

6. The notification mechanism of claim 5, wherein the sail includes the receiver.

7. The notification mechanism of claim 5, wherein the sail includes a fan, battery, and receiver.

8. A notification system to produce a unique series of tones comprising:
a sound generating device including at least one chime element, at least one striking element configured to strike the at least one chime element, and a motion imparting mechanism capable of moving the at least one striking element; and
an actuation mechanism in electrical communication with the sound generating device; wherein
a transmitter of the actuation mechanism is in electrical communication with a receiver of the sound generating device to produce the unique series of tones.

9. The notification system of claim 8, wherein the transmitter includes an AC to DC stepdown buck converter.

10. The notification system of claim 8, wherein the receiver is an RF receiver.

11. The notification system of claim 8, wherein the striking element is positioned along a vertical axis of a free-hanging pendulum adjacent to the at least one chime element.

12. The notification system of claim 8, wherein the sound generating device is a windchime.

13. The notification system of claim 12, further comprising a sail connected to the windchime.

14. The notification system of claim 13, wherein the sail includes the motion imparting mechanism.

15. The notification system of claim 14, wherein the motion imparting mechanism is an electric fan.

16. The notification system of claim 8, wherein the actuation mechanism is a doorbell.

17. The notification system of claim 16, wherein the doorbell has been modified to electrically bypass a doorbell chime to connect the transmitter.

18. The notification system of claim 8, wherein the transmitter is connected to a power transformer.

19. The notification system of claim 18, wherein the power transformer is connected to an AC voltage source.

20. A method of assembling a notification mechanism comprising:
connecting a transmitter to a doorbell assembly, so that actuating a doorbell causes the transmitter to send a signal to a receiver of a sound generating device; and
wherein the signal is received by the receiver of the sound generating device, and a unique series of tones is produced in response.
